(19) United States
(12) Patent Application Publication
(10) Pub. No.: US 2024/0269831 A1
(43) Pub. Date: Aug. 15, 2024

(54) DYNAMIC FORMATION OF MATERIAL HANDLING VEHICLE

(71) Applicant: International Business Machines Corporation, Armonk, NY (US)

(72) Inventors: Sarbajit K. Rakshit, Kolkata (IN); Michael Terrence Cohoon, Fishkill, NY (US); Martin G. Keen, Cary, NC (US); Jeremy R. Fox, Georgetown, TX (US)

(21) Appl. No.: 18/169,291

(22) Filed: Feb. 15, 2023

(51) Int. Cl. B25J 9/16

(52) U.S. Cl. CPC B25J 9/1617

(57) ABSTRACT

A computer system, computer readable storage medium, and computer-implemented method for operating a plurality of material handling units in a unitary configuration. The method includes determining objects to be transported from first locations to second locations. The method also includes gathering, subject to the determining the one or more objects, information with respect to characteristics of the objects. The method further includes determining, subject to the gathering of information, characteristics of a unitary material transport vehicle to transport the objects from the first locations to the second locations. The method also includes determining, subject to the determining the characteristics of the unitary material transport vehicle, a number of material handling units to form the unitary material transport vehicle. The method further includes assembling the unitary material transport vehicle. The unitary material transport vehicle includes the plurality of material handling units assembled into a unitary configuration.

### BACKGROUND

The present disclosure relates to material handling mechanisms, and, more specifically, toward implementing a system and method including a plurality of material handling units to operate in a unitary configuration.

Many known material handling and transportation mechanisms, including, without limitation, industrial floor material transportation mechanisms, involve many challenges in different fields such as control, communication, and coordination. For example, material movement in a shop floor relates to movements of spare parts, raw materials, assembled parts, etc. Material handling methods depend on the type of material, amount, and weight of material items to be handled. To distribute materials of varying dimensions, weights, and shapes, throughout a shop floor effectively, efficiently, and safely, coordination of the movement of an array of different material handling vehicles is a valuable attribute to employ. Therefore, within many known industrial settings, industrial floor material transportation is typically performed by a variety of tools, devices, and mechanisms including, without limitation, manually using hand-trucks and dollies, and through machines such as backhoe loaders, forklifts, trucks, and conveyors.

### SUMMARY

A system, medium, and method are provided for operating a plurality of material handling units in a unitary configuration.

In one aspect, a computer system for operating a plurality of material handling units in a unitary configuration is presented. The system includes one or more processing devices, one or more memory devices communicatively and operably coupled to the one or more processing devices, and a material handling tool at least partially resident within the one or more memory devices. The material handling tool configured to determine one or more objects to be transported from one or more first locations to one or more second locations, and gather, subject to the determining the one or more objects, information with respect to one or more characteristics of the one or more objects. The material handling tool is also configured to determine, subject to the gathering of information, one or more characteristics of a unitary material transport vehicle to transport the one or more objects from the one or more first locations to the one or more second locations. The material handling tool is also configured to determine, subject to the determining the one or more characteristics of the unitary material transport vehicle, a number of material handling units within a plurality of material handling units to form the unitary material transport vehicle. The material handling tool is further configured to assemble the unitary material transport vehicle. The unitary material transport vehicle includes the plurality of material handling units assembled into a unitary configuration.

In another aspect, a computer readable storage medium is presented. The computer readable storage medium includes computer executable instructions that when executed by at least one computing device operate a plurality of material handling units in a unitary configuration. The computer readable storage medium includes instructions for operating a plurality of material handling units in a unitary configuration. The computer readable storage medium includes instructions to determine one or more objects to be transported from one or more first locations to one or more second locations. The computer readable storage medium also includes instructions to gather, subject to the determining the one or more objects, information with respect to one or more characteristics of the one or more objects. The computer readable storage medium further includes instructions to determine, subject to the gathering of information, one or more characteristics of a unitary material transport vehicle to transport the one or more objects from the one or more first locations to the one or more second locations. The computer readable storage medium also includes instructions to determine, subject to the determining the one or more characteristics of the unitary material transport vehicle, a number of material handling units within a plurality of material handling units to form the unitary material transport vehicle. The computer readable storage medium further includes instructions to assemble the unitary material transport vehicle. The unitary material transport vehicle includes the plurality of material handling units assembled into a unitary configuration.

In yet another aspect, a computer-implemented method for operating a plurality of material handling units in a unitary configuration is presented. The method includes determining one or more objects to be transported from one or more first locations to one or more second locations, and gathering, subject to the determining the one or more objects, information with respect to one or more characteristics of the one or more objects. The method also includes determining, subject to the gathering of information, one or more characteristics of a unitary material transport vehicle to transport the one or more objects from the one or more first locations to the one or more second locations. The method further includes determining, subject to the determining the one or more characteristics of the unitary material transport vehicle, a number of material handling units within a plurality of material handling units to form the unitary material transport vehicle. The method also includes assembling the unitary material transport vehicle. The unitary material transport vehicle includes the plurality of material handling units assembled into a unitary configuration.

The present Summary is not intended to illustrate each aspect of every implementation of, and/or every embodiment of the present disclosure. These and other features and advantages will become apparent from the following detailed description of the present embodiment(s), taken in conjunction with the accompanying drawings.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are illustrative of certain embodiments and do not limit the disclosure.

FIG. 1A is a block diagram illustrating a computer system configured to execute operation of a plurality of material handling units in a unitary configuration, in accordance with some embodiments of the present disclosure.

FIG. 1B is a block diagram illustrating a material handling vehicle tool embedded within the computer system shown in FIG. 1A, in accordance with some embodiments of the present disclosure.

FIG. 2A is a schematic block diagram illustrating a bottom view of a material handling unit in a first mode of operation, in accordance with some embodiments of the present disclosure.

FIG. 2B is a schematic block diagram illustrating an overhead view of the material handling unit in the first mode of operation shown in FIG. 2A, in accordance with some embodiments of the present disclosure.

FIG. 2C is a schematic block diagram illustrating a side view of the material handling unit in the first mode of operation shown in FIGS. 2A and 2B, in accordance with some embodiments of the present disclosure.

FIG. 3A is a schematic diagram illustrating a bottom view of the material handling unit of FIGS. 2-4 in a second mode of operation, in accordance with some embodiments of the present disclosure.

FIG. 3B is a schematic diagram illustrating a side view of the material handling unit in the second mode of operation shown in FIG. 3A, in accordance with some embodiments of the present disclosure.

FIG. 3C is a schematic diagram illustrating an overhead view of the material handling unit in the second mode of operation shown in FIGS. 3A and 3B, in accordance with some embodiments of the present disclosure.

FIG. 4 is a schematic diagram illustrating overhead and side views of a plurality of the material handling units in the second mode of operation as shown in FIGS. 3A-3C, in accordance with some embodiments of the present disclosure.

FIG. 5 is a schematic diagram illustrating overhead and side views of the plurality of the material handling units in the second mode of operation shown in FIG. 4 mechanically coupled, in accordance with some embodiments of the present disclosure.

FIG. 6A is a flowchart illustrating the process shown in FIG. 6, in accordance with some embodiments of the present disclosure.

FIG. 6B is a continuation of the flowchart shown in FIG. 6A, in accordance with some embodiments of the present disclosure.

FIG. 6C is a continuation of the flowchart shown in FIG. 6B, in accordance with some embodiments of the present disclosure.

FIG. 7 is a schematic diagram illustrating a process including implementation of the plurality of the material handling units in the first and second modes, in accordance with some embodiments of the present disclosure.

FIG. 8 is as block schematic diagram illustrating an example of a computing environment for the execution of at least some of the computer code involved in performing the disclosed methods described herein, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate to implementing a system and method including a plurality of material handling units to operate in a unitary configuration. While the present disclosure is not necessarily limited to such applications, various aspects of the disclosure may be appreciated through a discussion of various examples using this context.

It will be readily understood that the components of the present embodiments, as generally described and illustrated in the Figures herein, may be arranged and designed in a wide variety of different configurations. Thus, the following detailed description of the embodiments of the apparatus, system, method, and computer readable storage medium of the present embodiments, as presented in the Figures, is not intended to limit the scope of the embodiments, as claimed, but is merely representative of selected embodiments.

Reference throughout this specification to “a select embodiment,” “at least one embodiment,” “one embodiment,” “another embodiment,” “other embodiments,” or “an embodiment” and similar language means that a particular feature, structure, or characteristic described in connection with the embodiment is included in at least one embodiment. Thus, appearances of the phrases “a select embodiment,” “at least one embodiment,” “in one embodiment,” “another embodiment,” “other embodiments,” or “an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

As used herein, “facilitating” an action includes performing the action, making the action easier, helping to carry the action out, or causing the action to be performed. Thus, by way of example and not limitation, instructions executing on one processor might facilitate an action carried out by semiconductor processing equipment, by sending appropriate data or commands to cause or aid the action to be performed. Where an actor facilitates an action by other than performing the action, the action is nevertheless performed by some entity or combination of entities.

Many known material handling and transportation mechanisms, including, without limitation, industrial floor material transportation mechanisms, involve many challenges in different fields such as control, communication, and coordination. For example, material movement in a shop floor relates to movements of spare parts, raw materials, assembled parts, etc. Material handling methods depend on the type of material, amount, and weight of material items to be handled. To distribute materials of varying dimensions, weights, and shapes, throughout a shop floor effectively, efficiently, and safely, coordination of the movement of an array of different material handling vehicles is a valuable attribute to employ.

Therefore, within many known industrial settings, industrial floor material transportation is typically performed by a variety of tools, devices, and mechanisms including, without limitation, manually using hand-trucks and dollies, and through machines such as backhoe loaders, forklifts, trucks, and conveyors. Each of these known mechanisms for transporting materials through an industrial environment presents certain drawbacks. Manual transport includes inherent safety considerations as people move across the industrial floor. Machines such as backhoe loaders, forklifts, and trucks include size, obstruction, and maneuverability issues that limit their useability, especially in constrained and human-populated areas. For example, in general, forklifts are used in a relatively limited area to pick and move product within a range of up to a few hundred feet. Some of these known transportation methods have fixed attributes with limitations on the weight and dimensions of materials that can be carried, and in the case of a conveyor, in the routing they take, i.e., conveyors move materials along fixed, predetermined paths. In addition, as different dimensions and weights of materials can be varied, different material handling vehicles may be required, and will be occupying at least a portion of the floor space.

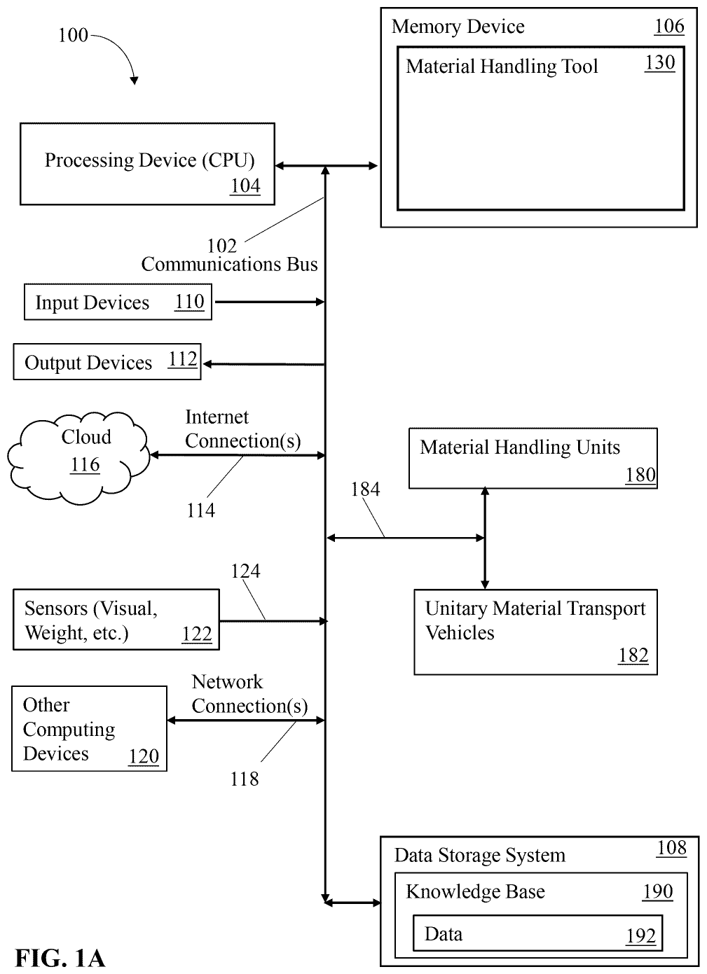

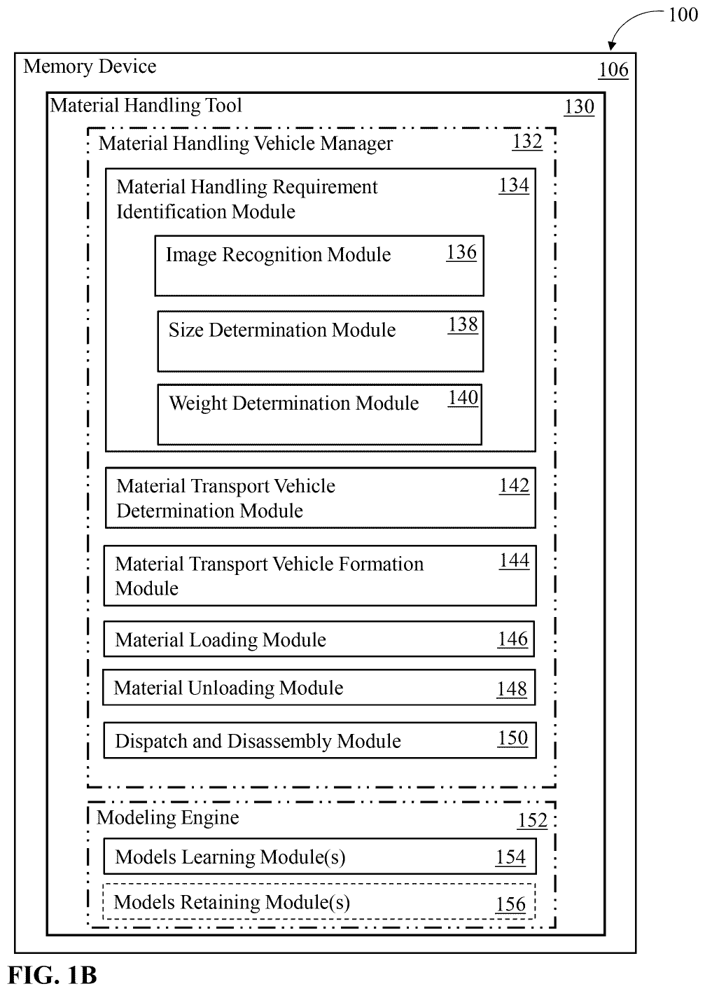

Referring to FIG. 1A, a block diagram is presented illustrating a computer system, i.e., a material handling system 100 (herein referred to as “the system 100”) configured to execute operation of a plurality of material handling units/vehicles 180 (shown and described further herein) in a unitary configuration, in accordance with some embodiments of the present disclosure. The system 100 includes one or more processing devices 104 (only one shown) communicatively and operably coupled to one or more memory devices 106 (only one shown) through a communications bus 102, and in some embodiments, through a memory bus (not shown). In some embodiments, the processing device 104 is a multicore processing device. The system 100 also includes a data storage system 108 that is communicatively coupled to the processing device 104 and memory device 106 through the communications bus 102. In at least some embodiments, the data storage system 108 provides storage to, and without limitation, a knowledge base 190 that includes at least a portion of the data 192 to enable operation of the system 100 as described further herein.

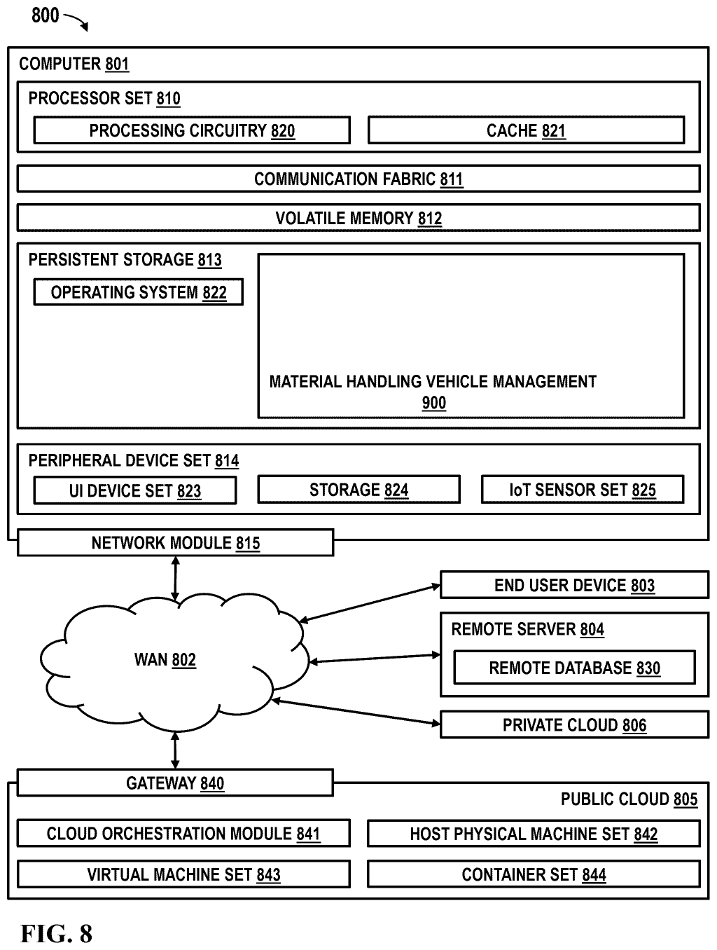

The system 100 further includes one or more input devices 110 and one or more output devices 112 communicatively coupled to the communications bus 102. In addition, the system 100 includes one or more Internet connections 114 (only one shown) communicatively coupled to the cloud 116 through the communications bus 102, and one or more network connections 118 (only one shown) communicatively coupled to one or more other computing devices 120 through the communications bus 102. In some embodiments, the Internet connections 114 facilitate communication between the system 100 and one or more cloud-based centralized systems and/or services (not shown in FIG. 1). In at least some embodiments, the system 100 is a portion of a cloud computing environment (see FIG. 8), e.g., and without limitation, the system 100 is a computer system/server that may be used as a portion of a cloud-based systems and communications environment through the cloud 116 and the Internet connections 114.

In addition, the system 100 includes one or more sensors 122 (visual, weight, proximity, etc.) that are communicatively and operably coupled to the processing device 104 and the memory device 106 through a communications conduit 124 and the communications bus 102. Moreover, the system 100 includes a plurality of individual material handling units 180 that are used to form one or more unitary material transport vehicles 182 that that are communicatively and operably coupled to the processing device 104 and the memory device 106 through a communications conduit 184 and the communications bus 102.

In one or more embodiments, a material handling tool 130 (herein referred to as “the tool 130”) is at least partially resident within the memory device 106. In some embodiments, the tool 130 is fully resident within the memory device 106. The tool 130 is discussed in detail further in this disclosure. The tool 130 is configured to execute, with full or partial automation, tasks that include, without limitation, determining one or more objects and/or materials to be transported from one or more first locations (e.g., storage areas and shipping/receiving areas) to one or more second locations (e.g., staging/manufacturing/assembly areas). In addition, the tool 130 is configured to execute, with full or partial automation, tasks that include, without limitation, gathering information with respect to one or more characteristics of the one or more objects and materials, and determining one or more characteristics of a unitary material transport vehicle to transport the one or more objects from the one or more first locations to the one or more second locations. Moreover, the tool 130 is configured to execute, with full or partial automation, tasks that include, without limitation, determining a number of material handling units within a plurality of material handling units to form the unitary material transport vehicle, and assembling the unitary material transport vehicle, where the unitary material transport vehicle includes the plurality of material handling units assembled into a unitary configuration.

In at least some embodiments, the tool 130 resident in the memory device 106 is configured to run continuously in the background to automatically execute the processes associated with the material handling units and the unitary material transport vehicles. In some embodiments, the tool 130 is directly engaged for specific tasking by the users thereof, e.g., and without limitation, manual execution commands.

Referring to FIG. 1B, a block diagram is presented illustrating the material handling tool 130 embedded within the memory device 106 of the system 100, in accordance with some embodiments of the present disclosure. Also continuing to refer to FIG. 1A, in at least some embodiments, the tool 130 is configured to execute the material handling operations described herein. The tool 130 includes a material handling vehicle manager 132 that is configured to manage the operation of the individual material handling components as described further herein. As shown in FIG. 1B, the material handling vehicle manager 132 includes the modules for the respective operable components. In some embodiments, the material handling vehicle manager 132 is a stand-alone module that is communicatively and operatively coupled to the individual components. The tool 130 also includes a material handling requirement identification module 134 that is configured to leverage devices, such as, and without limitation, the sensors 122 to determine the physical characteristics of the objects that will need to be transported from the first location to the second location. Such physical characteristics include, without limitation, precise identification of the objects to be moved, exactly where the objects are presently located, the orientations as to how they are stored, the size and weight of the objects, etc. Therefore, the material handling requirement identification module 134 includes modules such as an image recognition module 136, a size determination module 138, and a weight determination module 140.

Continuing to refer to FIGS. 1A and 1B, in one or more embodiments, the material handling vehicle manager 132 also includes a material transport vehicle determination module 142 that is configured to define a number of the individual material handling units 180 that will be required to form the respective unitary material transport vehicles 182. The material handling vehicle manager 132 further includes a material transport vehicle formation module 144 that is configured to directly manage the formation activities of the unitary material transport vehicles 182 by the respective individual material handling units 180 in conjunction with a dispatch and disassembly module 150 that is configured to dispatch the individual material handling units 180 from their present location to the desired location.

In at least some embodiments, the material handling vehicle manager 132 includes a material loading module 146 and a material unloading module 148 that are configured to manage the respective unitary material transport vehicles 182 during material loading and unloading operations, respectively. The dispatch and disassembly module 150 is further configured to execute disassembly operation of the unitary material transport vehicles 182 into the individual material handling units 180 in preparation for further dispatch to the desired locations for the units 180.

In some embodiments, the tool 130 further includes a modeling engine 152. The modeling engine 152 includes one or more models learning modules 154 and one or more models retaining modules 156 embedded therein. The models learning modules 154 are configured to train the models that are resident in the models retaining modules 156. The modeling engine 152 facilitates determining which models for particular situations are most likely to be used for each respective situation and providing access to the selected models.

The modeling engine 152 used machine learning tools and methods to process large volumes of data, seemingly related or unrelated, where the machine learning systems may be trained with data derived from a database or corpus of knowledge, as well as recorded behavioral data. The machine learning systems look for, and determine, patterns, or lack thereof, in the data, “learn” from the patterns in the data, and ultimately accomplish tasks without being given specific instructions. In addition, the machine learning systems, utilizing algorithms represented as machine processable models, learn from the data and create foresights based on this data.

In one embodiment, one or more high-fidelity machine learning models of the material handling units (described further herein) is resident within the models retaining modules 156. Herein, the terms “model” and “models” includes “one or more models.” Therefore, as a portion of data ingestion by the model, data 192 resident within a knowledge base 190 is injected into the model (data storage is described elsewhere herein). As such, the modeling engine 152 uses this corpus to predict and identify a pattern for material handling units in such a way that the units are consistently operated to avoid collisions thereof. At least a portion of the data 192 includes data associated with successful unit dispatching, as well as unsuccessful events is used to perform the initial training of the models resident in the models retaining modules 156 through the models learning modules 154. In addition, the modeling engine 152 facilitates continuous training of the models with the collected data.

Further, referring to FIG. 1A, in some embodiments, the data storage system 108 is configured to maintain a knowledge base 190 that includes any data 192 the material handling tool 130 needs for proper material handling execution. The data storage system 108 is also configured to store the data 192 collected during the material transport operations, including the data 192 collected during the assembly and disassembly of the unitary material transport vehicles 182 with the individual material handling units 180.

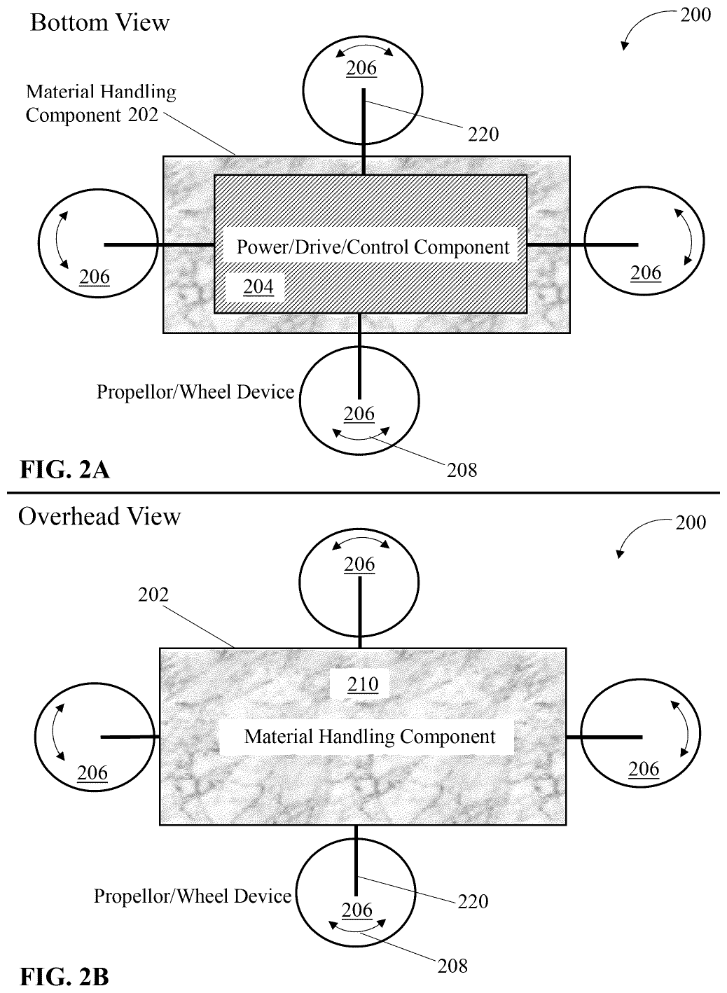

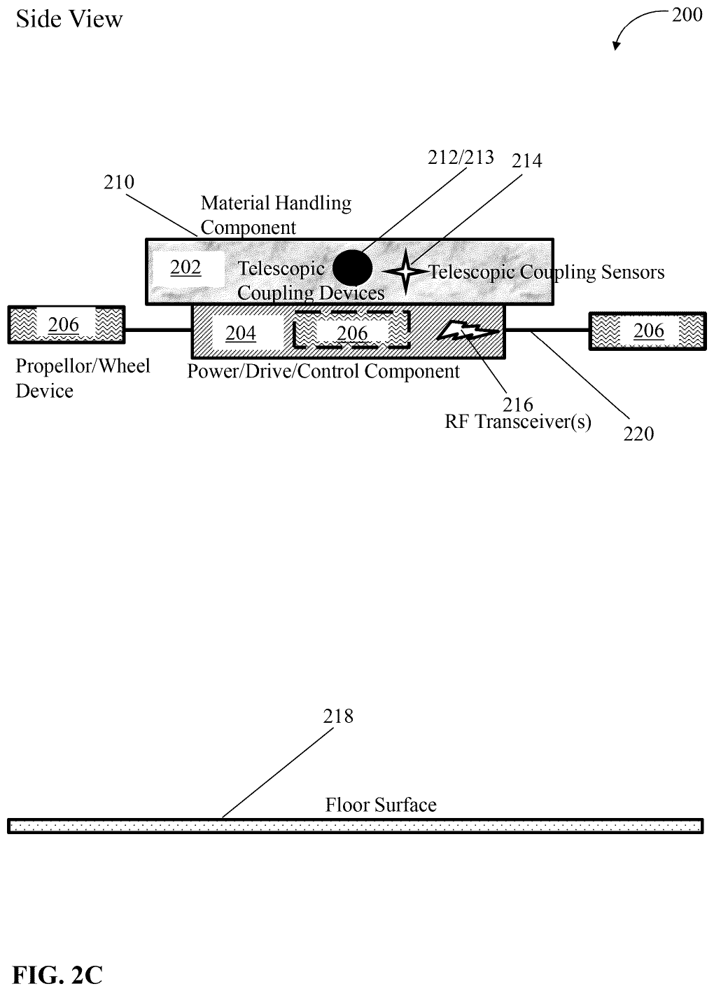

Referring to FIG. 2A, a schematic block diagram illustrating a bottom view of a material handling unit 200 (referred to as material handling units 180 in FIG. 1A) in a first mode of operation, in accordance with some embodiments of the present disclosure. FIG. 2A is not drawn to scale. The first mode of operation is flying mode. The material handling unit 200 includes a material handling component 202 that is configured to interface with the material handling vehicle manager 132 (shown in FIG. 1B) to execute the operations as directed by the manager 132. The material handling component 202 is shown as rectangular; however, in some embodiments, the material handling component 202 has any shape and configuration that enables operation of the material handling unit 200 and the system 100 as described herein. Also, the material handling unit 200 includes a power/drive/control component 204 that is configured to provide electrical and mechanical power, drive features, cooling features (e.g., heat exchangers, cooling fins, cooling fluid recycling), and control features for the material handling unit 200 to cooperate with the material handling component 202 that is configured to execute the operations as directed by the material handling vehicle manager 132.

The power/drive/control component 204 is mechanically coupled to the material handling component 202, and in some embodiments, they are removably coupled to each other. In addition, the material handling unit 200 includes a plurality of propellor/wheel devices 206 (four shown) that are configured to rotate one or more of clockwise and counter clockwise as indicated by the arrows 208 (only one labeled). In some embodiments, any number of the propellor/wheel devices 206 in any configuration are used that enables operation of the material handling units 200 as described herein. In some embodiments, the propellor/wheel devices 206 are variably added and removed for the impending tasks, and in some embodiments, the propellor/wheel devices 206 are retractable to aid in storage and to extend the operation of the material handling units 200 with respect to power conservation.

Referring to FIG. 2B, a schematic block diagram is presented illustrating an overhead view of the material handling unit 200 in the first mode of operation shown in FIG. 2A, in accordance with some embodiments of the present disclosure. FIG. 2B is not drawn to scale. The material handling component 202 includes a material handling surface 210 that is shown as substantially flat; however, in some embodiments, the material handling surface 210 has any shape and configuration that enables operation of the material handling unit 200 and the system 100 as described herein. In some embodiments, the material handling component 202 includes accessories to facilitate loading and securing the objects and materials to the material handling unit 200 to mitigate any chance for load shifting during transport. Such accessories (not shown) include, without limitation, grasping devices to load (and unload) the objects and materials to the material handling surface 210, telescopic poles for pushing the objects and materials off of the material handling surface 210, clamps, straps, etc.

Referring to FIG. 2C, a schematic block diagram is presented illustrating a side view of the material handling unit 200 in the first mode of operation shown in FIGS. 2A and 2B, in accordance with some embodiments of the present disclosure. FIG. 2C is not drawn to scale. As shown in FIG. 2C, the material handling unit 200 is hovering over a floor surface 218. In some embodiments, the material handling component 202 includes one or more telescopic coupling devices 212 (only one shown; however, up to four are possible with the illustrated configuration) with the operable equipment (not shown) necessary to extend and retract the telescopic coupling devices 212 including, without limitation, drive devices, hydraulics, etc. In some embodiments, the material handling component 202 includes the power supplies for extending and retracting the telescopic coupling devices 212, and in some embodiments, the power is supplied from the power/drive/control component 204. In some embodiments, rather than a telescopic coupling device 212, some of the material handling units 200 include a receiving aperture 213 configured to receive a telescopic coupling device 212 from adjacent material handling units 200, where the devices 212 and receiving apertures 213 are distinguished further herein. The material handling component 202 further includes one telescopic coupling sensor 214 for each telescopic coupling device 212 that senses if the respective telescopic coupling device 212 has successfully coupled to another material handling unit 200. In some embodiments, the telescopic coupling sensors 214 are any sensors that enable operation of the material handling units 200 as described herein, including, without limitation, one or more of proximity switches, linear voltage differential transformers (LVDTs), snap-action plunger switches, torque sensors, contact switches including, without limitation, reed switches, etc.

In some embodiments, the power/drive/control component 204 includes one or more radio frequency (RF) transceivers 216 that are configured to communicate with the material handling vehicle manager 132 (shown in FIG. 1B) to execute the operations as directed by the manager 132. In some embodiments, the power/drive/control component 204 includes separate RF transmitters and receivers, including those that operate a different frequencies for certain aspects of individualized control of the material handling units 200. Moreover, in some embodiments the power/drive/control component 204 provides all of the power for the respective material handling unit 200. In some embodiments, the material handling component 202 has its own power supply devices and does not routinely use the power from the power/drive/control component 204. Therefore, in some embodiments, one or both of the material handling component 202 and the power/drive/control component 204 includes one or more charging ports (not shown).

In at least some embodiments, the material handling units 200 include one or more propellor/wheel drive shafts 220 (only one labeled) the extends from the power/drive/control component 204 to the respective propellor/wheel device 206. In some embodiments, the drive motors for the propellor/wheel devices 206 are positioned within the power/drive/control component 204 and the propellor/wheel drive shafts 220 transmit rotational torque to the propellor/wheel devices 206, where such torque is reversible. In some embodiments, the propellor/wheel drive shaft 220 is a wire/cable conduit that transmits electric power to a drive motor (not shown) positioned on the respective propellor/wheel device 206. Note that the drive shaft 220 for the center propellor/wheel device 206 in FIG. 2C is hidden and the fourth propellor/wheel device 206 and respective drive shaft 220 are not shown due to the perspective of the figure.

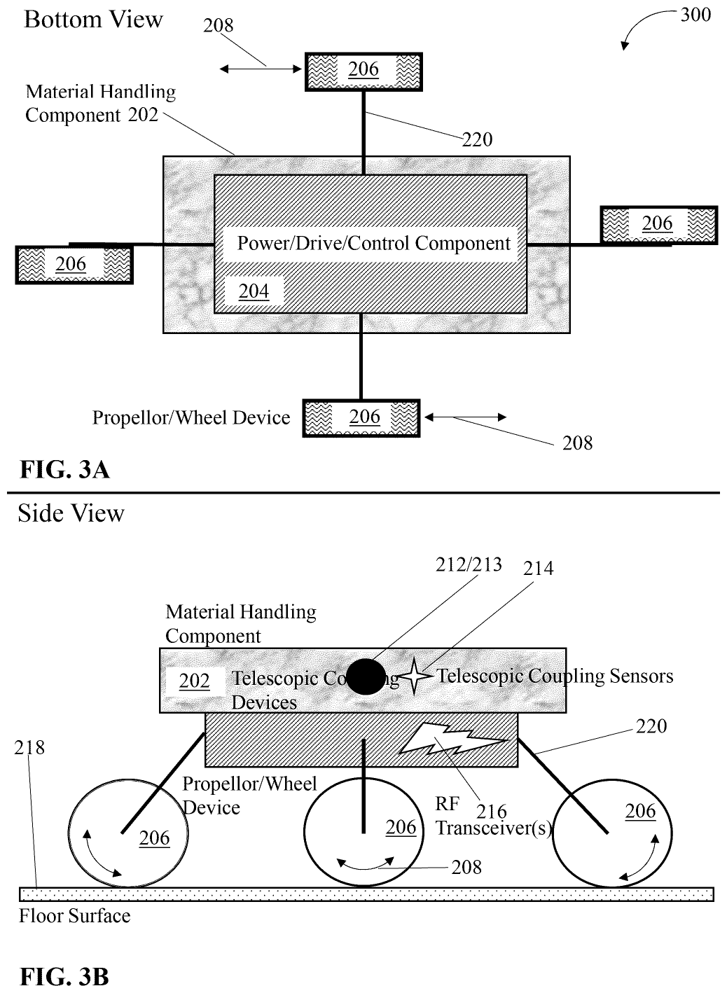

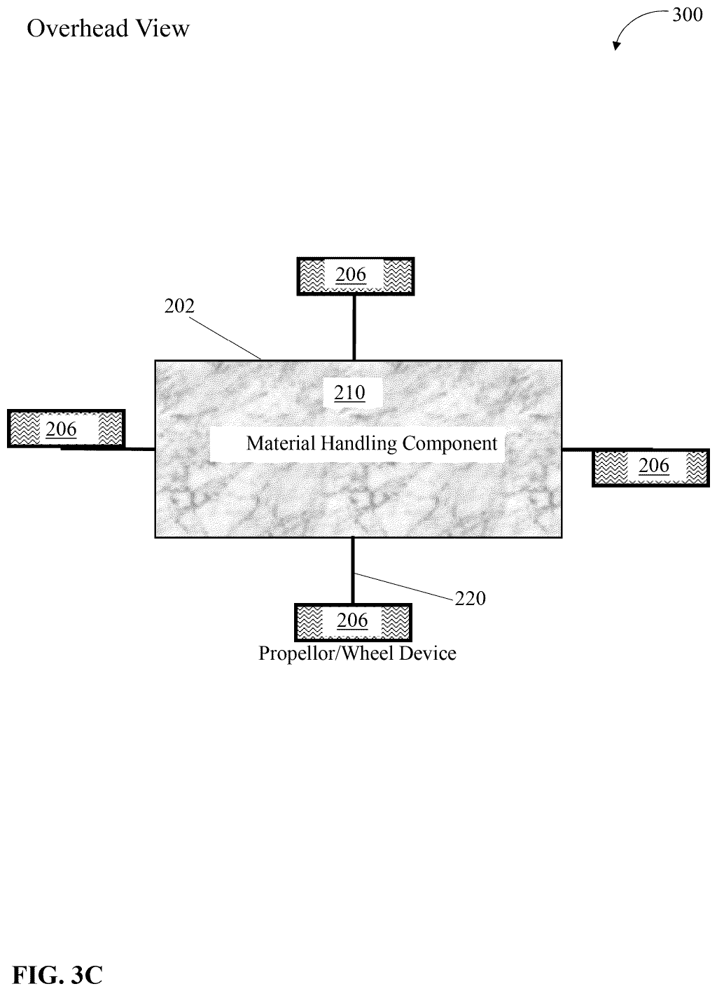

Referring to FIG. 3A, a schematic diagram is presented illustrating a bottom view of the material handling unit 300 (referred to as the material handling unit 200 in FIGS. 2A-2C) in a second mode of operation, in accordance with some embodiments of the present disclosure. FIG. 3A is not drawn to scale. In general, the reference numbers used in FIGS. 2A-2C are used in FIG. 3A, where the reference number 300 is used to distinguish the second mode of operation (i.e., floor mode) from the first mode of operation (i.e., the flight mode) that uses the reference number 200. In the floor mode of operation for the material handling unit 300, the propellor/wheel device 206 is in the wheel mode as compared to the propellor mode for the flight mode of operation for the material handling unit 200.

Referring to FIG. 3B, a schematic diagram is presented illustrating a side view of the material handling unit 300 in the floor mode of operation shown in FIG. 3A, in accordance with some embodiments of the present disclosure. FIG. 3B is not drawn to scale. Note that the fourth propellor/wheel device 206 and respective drive shaft 220 are not shown due to the perspective of the figure. Referring to FIG. 3C, a schematic diagram is presented illustrating an overhead view of the material handling unit 300 in the floor mode of operation shown in FIGS. 3A and 3B, in accordance with some embodiments of the present disclosure. FIG. 3C is not drawn to scale.

In some embodiments, the physical dimensions for the material handling unit 200 in the flight mode (see FIGS. 2A-2C) are for the material handling component 202 approximately 2 feet in length, approximately 1 foot in width, and approximately 0.5 feet in height, for the power/drive/control component 204 approximately 1.5 feet in length, approximately 0.75 feet in width, and approximately 0.5 feet in height, and the propellor wheel device 206 is approximately 0.5 feet in diameter. Accordingly, in the flight mode the material handling unit 200 is approximately 3 feet in length, 2 feet in width, and approximately 1 foot in height. Similarly, in some embodiments, the physical dimensions for the material handling unit 300 in the floor mode (see FIGS. 3A-3C) are approximately 2.5 feet in length, 1.5 feet in width, and approximately 1.5 feet in height, where the differences from the flight mode are substantially due to the position and orientation of the propellor wheel devices 206. In some embodiments, the material handling units 200/300 have any dimensions that enable the system 100 as described herein.

As used herein, the term “material handling unit 200/300” is used when the mode of operation, i.e., flight and floor, are not relevant to the immediate discussion and the specific details under discussion apply to both modes of operation. As such, when the flight mode of operation is distinguished from the floor mode of operation, the use of the terms “material handling unit 200” and “material handling unit 300,” respectively, are used.

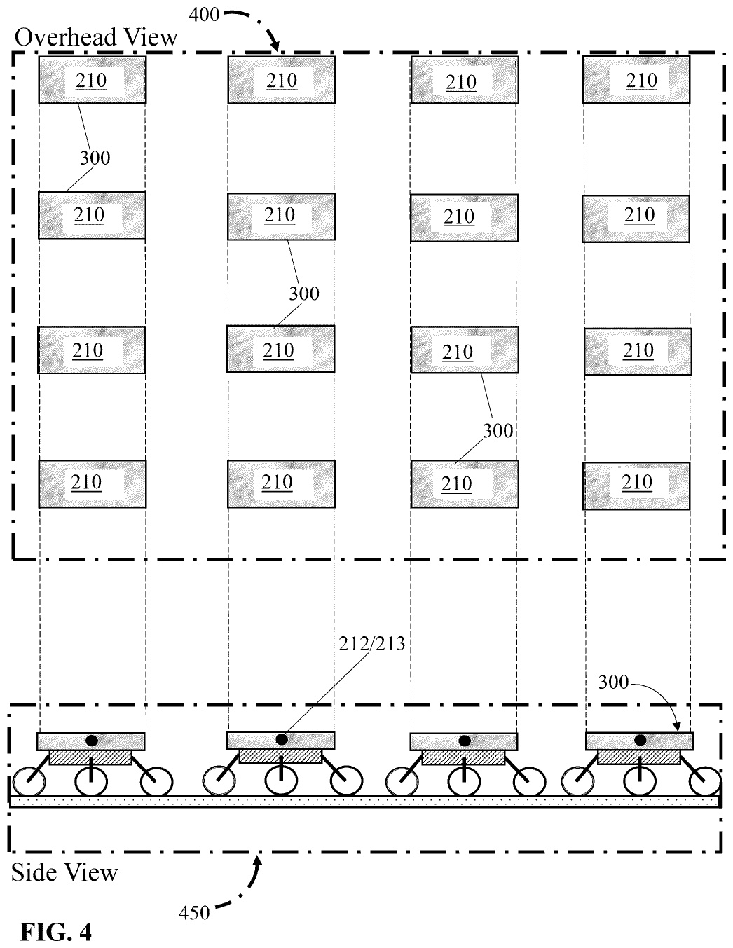

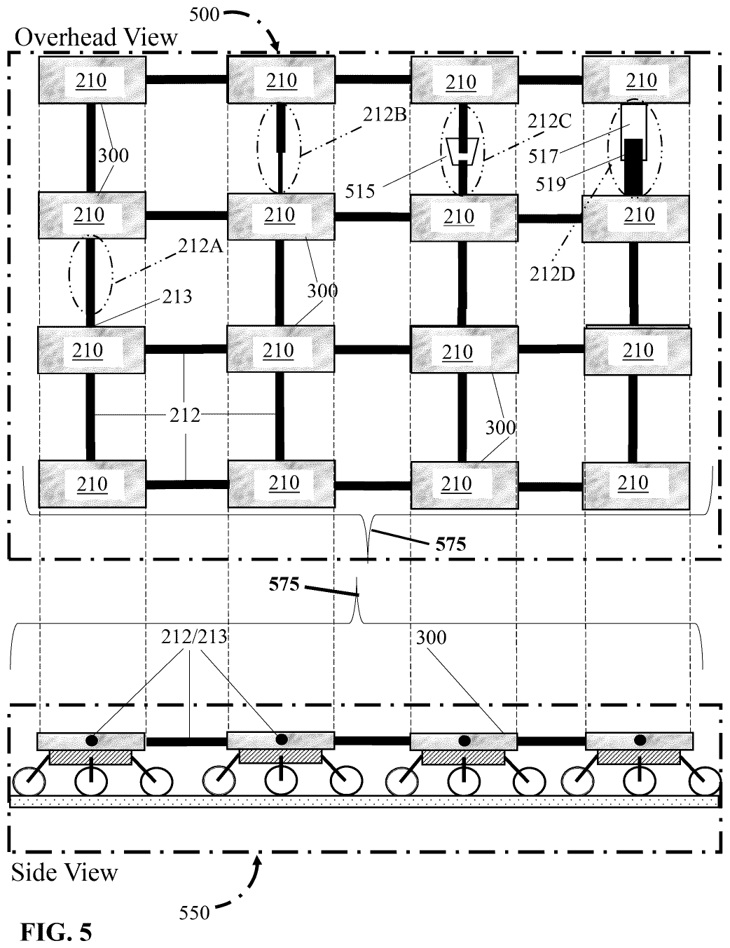

Note that in some embodiments shown, the power/drive/control component 204 is sized to be large enough to optimize the power supply duration for the intended tasks of the material handling unit 200/300, taking into account the increased power duration comes with a price of increased weight of the component 204. In addition, the lifting/carrying capacities of the material handling component 202 may be increased through more robust fabrication materials and greater size with similar tradeoffs in power duration from the power/drive/control component 204. Furthermore, the use of electromagnet coupling devices (discussed further herein) will also increase the power demand on the power/drive/control component 204, as well as the weight of the material handling unit 200/300. Accordingly, limitations to the overall size, weight, and capacity of the individual material handling units 200/300 are typically determined by the operators of the material handling units 200/300. However, as further described with respect to FIGS. 4 and 5 of this disclosure, a plurality of material handling units 300 are positioned to assemble a plurality of material handling surfaces 210 configured to define a larger material handling surface that is approximately the sum of the material handling surfaces 210. In some embodiments, each material handling unit 200/300 is assigned a unique ID which remains visible to the system 100 throughout its service time for identification purposes.

Referring to FIG. 4, a schematic diagram is presented illustrating an overhead view 400 (as shown in FIG. 3C) and a side view 450 (as shown in FIG. 3B) of a plurality of the material handling units 300 in the second mode of operation, in accordance with some embodiments of the present disclosure. The plurality of material handling units 300 are positioned and configured for subsequent joining, i.e., coupling through the respective telescopic coupling devices 212 to assemble a plurality of material handling surfaces 210 to define a larger material handling surface that is approximately the sum of the material handling surfaces 210.

Referring to FIG. 5, a schematic diagram is presented illustrating an overhead view 500 and a side view 550 of the plurality of the material handling units 300 mechanically coupled in the second mode of operation shown in FIG. 4, in accordance with some embodiments of the present disclosure. FIG. 5 is not drawn to scale in order to emphasize the coupling devices. In some embodiments, the plurality of the material handling units 300 define a unitary material transport vehicle 575 (referred to as the unitary material handling unit 182 in FIG. 1A).

In some embodiments, the telescopic coupling device 212 is a unitary extension 212A from either of two adjacent material handling units 300 that has substantially constant cross-sectional dimensions whether the configuration of the unitary extension 212A is rectangular, cylindrical, etc. In some embodiments, the unitary extension 212A is fabricated from any materials with certain structural properties, e.g., and without limitation, carbon fibers that offer low weight yet high strength structural features. The adjacent material handling units 300 include a receiving aperture 213 configured to securely receive the unitary extension 212A through mechanisms such as, and without limitation, friction fits, mechanical latching devices, electromagnets, etc. The unitary extension 212A is configured to couple the two adjacent material handling units 300 automatically without human intervention.

In some embodiments, the telescopic coupling device 212 includes a plurality of telescoping concentric sections 212B. In some embodiments, all of the telescoping concentric sections 212B extend entirely from a single material handling unit 300 into an adjacent material handling unit 300. In some embodiments, the telescoping concentric sections 212B extend from one of the adjacent material handling units 300 into the complementary aperture 213 to securely couple each other through mechanisms such as, and without limitation, friction fits, mechanical latching devices, electromagnets, etc. The telescoping concentric sections 212B are configured to couple the two adjacent material handling units 300 automatically without human intervention.

In some embodiments, the telescopic coupling device 212 includes a plurality of sections 212C, where one of the sections includes a coupling mechanism such as, and without limitation, a mechanical coupling device 515 configured to couple the two adjacent material handling units 300 automatically without human intervention. In some embodiments, the mechanical coupling device 515 is complimented with one or more of mechanical latching devices and electromagnets, and where the frustoconical shape of the mechanical coupling device 515 is non-limiting. The plurality of sections 212C with the mechanical coupling device 515 are configured to couple the two adjacent material handling units 300 automatically without human intervention.

In some embodiments, the telescopic coupling device 212 includes a plurality of sections 212D, where a first portion 517 of the telescopic coupling device 212 extending from a first adjacent material handling unit 300 is configured to extend into a second portion 519 of the telescopic coupling device 212 extending from a second adjacent material handling unit 300. The plurality of sections 212D are configured to securely couple each other through mechanisms such as, and without limitation, friction fits, mechanical latching devices, electromagnets, etc. The plurality of sections 212D are configured to couple the two adjacent material handling units 300 automatically without human intervention.

In some embodiments, the material handling units 200/300 are referred to as “drones,” “assets,” and “robots.” The material handling units 200/300 as described herein are configured for air (the first, or flight configuration) and land (the second, or floor configuration). In some embodiments, the material handling units 200/300 are configured for gaseous environments other than air, including those environments that are not hospitable to humans. In some embodiments, the material handling units 200/300 are configured for a third, i.e., hydro- or waterborne, configuration either exclusively or in addition to the flight and floor configurations. In some of those embodiments, some of the waterborne material handling units 200/300 are configured for one or both of sea water and fresh water, as well as, in some embodiments, fluid environments other than substantially water.

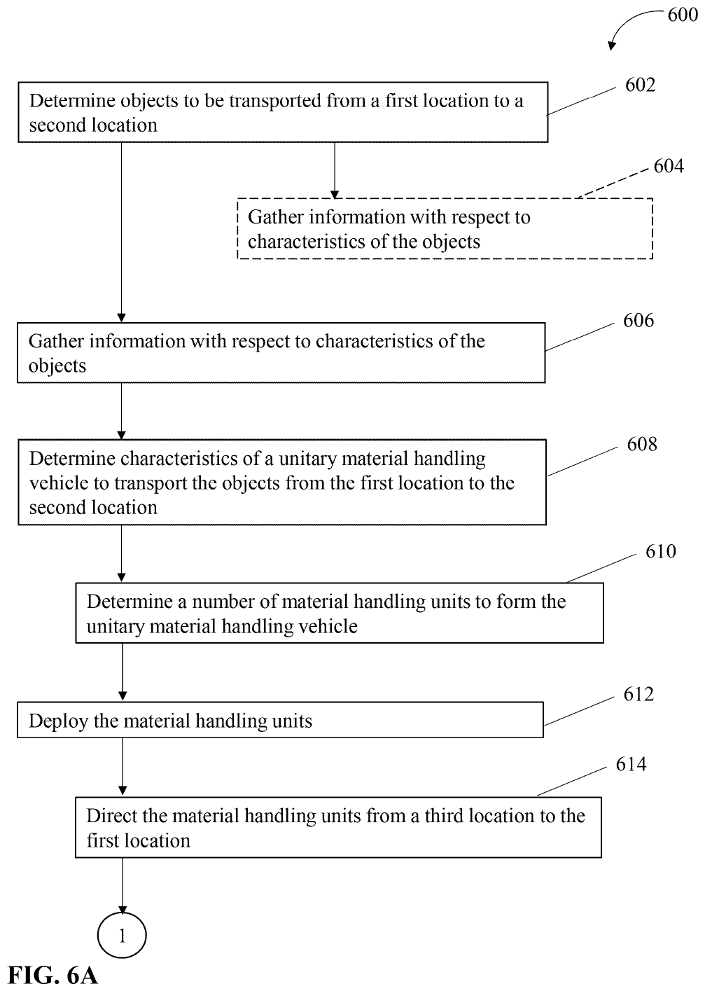

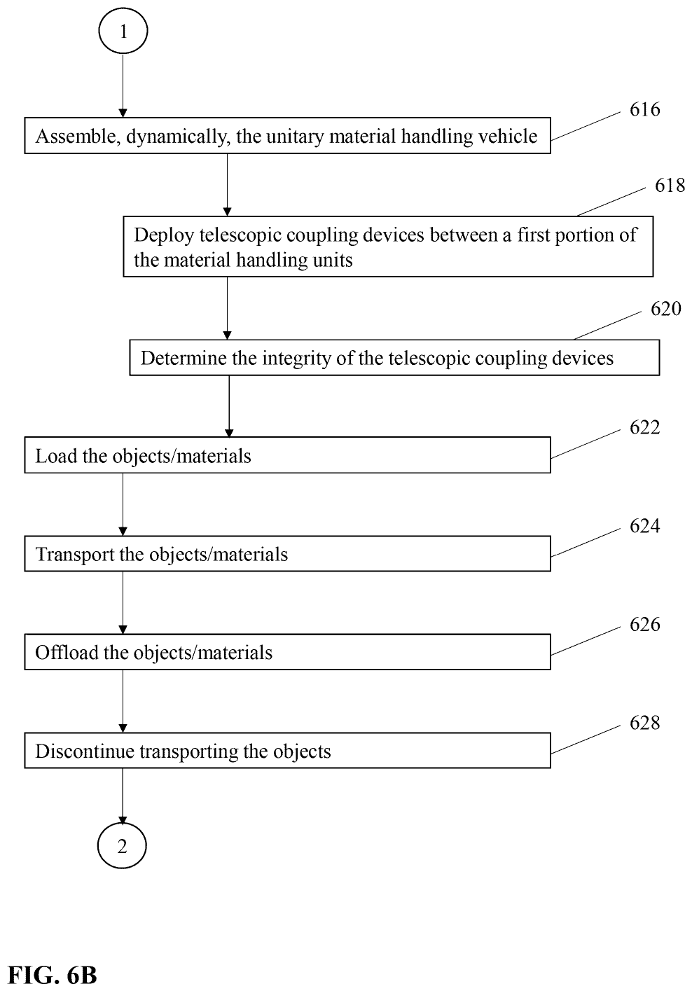

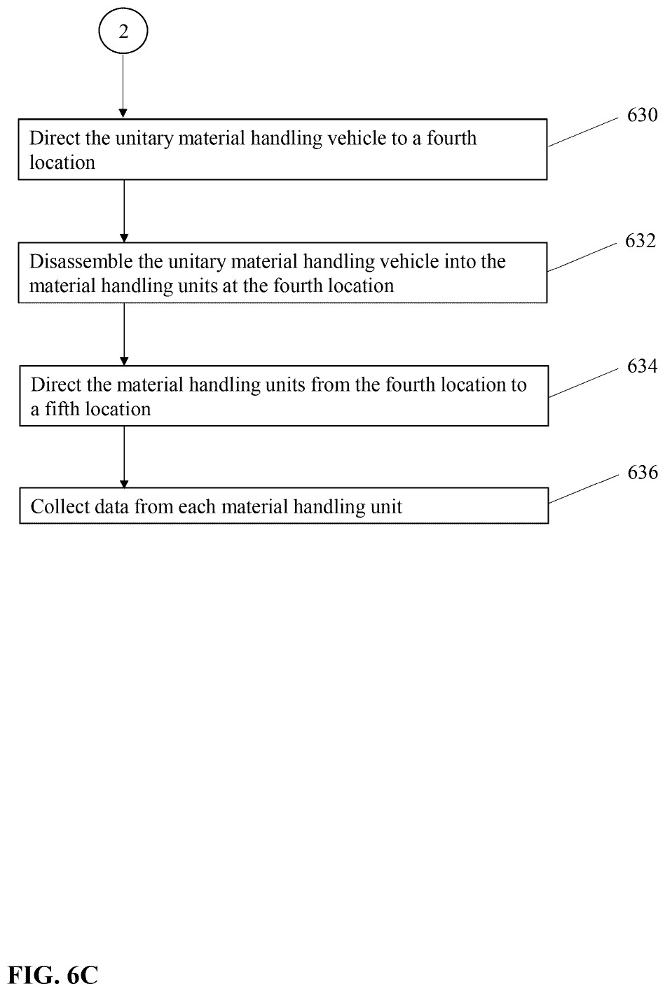

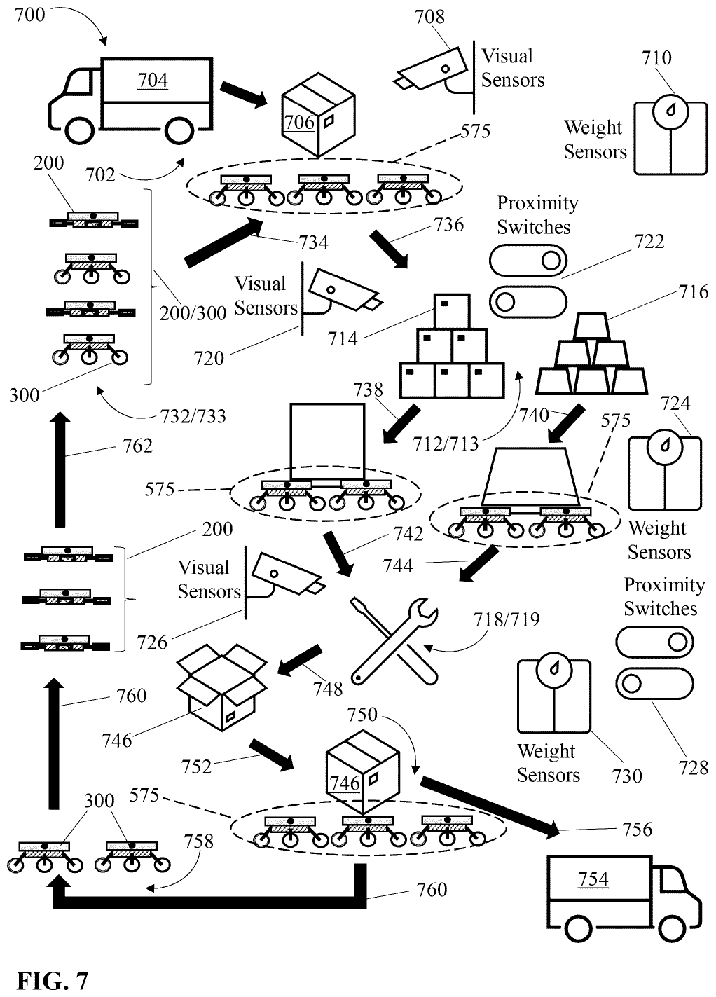

Referring to FIG. 6A, a flowchart is provided illustrating a process 600 for operating a plurality of a plurality of material handling units 200/300 in a unitary configuration, in accordance with some embodiments of the present disclosure. In addition, referring to FIG. 7, a schematic diagram is presented illustrating the process 600 including implementation 700 of the plurality of the material handling units 200/300 in the first and second modes, in accordance with some embodiments of the present disclosure. FIGS. 6 and 7 are discussed together.

In at least some embodiments, and also referring to FIGS. 1A-B, the process includes determining 602, through the material handling requirement identification module 134 (resident within the material handling vehicle manager 132, that in turn is resident within the material handling tool 130), one or more objects and/or materials to be transported from one or more first locations to one or more second locations. In general, the first locations are those locations where the objects and materials to be gathered are presently located such as, without limitation, dedicated object/material storage areas (warehouses, laydown areas, etc.) on the users' immediate property, other property locations, repair/refurbishment shops, etc. As shown in FIG. 7, in some embodiments, one such first location is a delivery/receiving/shipping area 702 (herein “the receiving area 702”), within an industrial facility, that has received a transport truck 704 loaded with one or more of the first objects, i.e., rectangular boxes 706.

In one or more embodiments, the determining method step 602 includes gathering 604 (shown in phantom), information with respect to one or more characteristics of the one or more objects, i.e., the rectangular boxes 706. Devices that are used for gathering 604 the information include the sensors 122 that include, without limitation, visual sensors 708 such as, without limitation, cameras (visible spectrum and infrared spectrum for determining temperature differences between the objects of interest and other proximate materials) and motion detectors. Also, devices that are used for gathering 604 the information of the rectangular boxes 706 include weight sensors 710, e.g., scales and load cells. In addition, the system 100 is configured to receive and use administrative information such as bills of lading, shipping receipts, purchase orders, etc., through one or more of the input devices 110, the cloud 116 via the Internet connections 114, and other computing devices 120 through the network connections 118, as well as historical shipping/receiving data resident within the knowledge base 190.

In at least some embodiments, the gathering step 604 includes, using the visual sensors 708 for determining the presence of the rectangular boxes 706 at the various locations throughout the respective facility, including the receiving area 702. In some embodiments, the gathering step 604 includes identifying these materials, i.e., the rectangular boxes 706, through an image recognition algorithm resident within the image recognition module 136. Also, in some embodiments, the results of the gathering 604 method step includes, without limitation, the determining the number of the rectangular boxes 706 delivered, as well as the number of the rectangular boxes 706 (with similar materials therein) located throughout the facility, if necessary. Further, the dimensions of the rectangular boxes 706 are determined through the visual sensors 708 and the image recognition module 136 that is resident within the material handling requirement identification module 134. In addition, the size, i.e., each of the dimensions of each rectangular box 706 is determined through the visual sensors 708 proximate to the receiving area 702 and the size determination module 138 that is resident within the material handling requirement identification module 134. Moreover, the weight of each rectangular box 706 is determined through the weight sensors 710 proximate to the receiving area 702 and the weight determination module 140 that is resident within the material handling requirement identification module 134.

In some embodiments, the nature of the contents within the rectangular boxes 706 is determined through the administrative information associated with the shipment as well as historical shipping/receiving data 192 resident within the knowledge base 190. The determined sizes and weights of the rectangular boxes 706 automatically determined through the suite of sensors (e.g., the visual sensors 708 and the weight sensors 710) in the vicinity of the receiving area 702 are compared with the data 192 for similar items resident within the knowledge base 190, and any determined discrepancies are automatically resolved through further analysis of the aforementioned data. Accordingly, the location, number, size, weight, and nature (e.g., contents) of the rectangular boxes 706 extracted from the transport truck 704 are determined 602 through the gathering information step 604.

The embodiments previously presented for the determining method step 602 and the gathering step 604 are directed toward pending receipt and unloading of a shipment. In contrast, and in at least some embodiments, the determining method step 602 is initiated through receipt of a request for particular objects that are presently positioned such that retrieval with the material handling units 200/300 in the configuration of the unitary material transport vehicle 575 (see FIG. 5) is enabled. Referring to FIG. 7 again, in some embodiments, such objects are positioned within a storage area 712, that is, in some embodiments, an object repair/refurbishment area 713. In at least some of such embodiments, the objects include a plurality of first objects 714 and a plurality of second objects 716, where the first objects 714 and the second objects 716 are determined to be transported from one or more first locations to one or more second locations. To facilitate the discussion, the plurality of first objects 714 are a plurality of the rectangular boxes 706 and the plurality of second objects 716 includes a plurality of frustoconical objects.

In some embodiments, the first location is the storage area 712 and the second location is an assembly area 718. In some embodiments, the first location is the object repair/refurbishment area 713. In some embodiments, the second location is another object repair/refurbishment area 719. In other embodiments, the first location includes one or more of any areas where the objects to be collected are presently located and the second location includes one or more of any areas where the objects are to be delivered. In some embodiments, the objects 714 and 716 are identified through one or more of a work order, a purchase order, the object data 192 in the data corpus 190, etc. Accordingly, the objects to be transported are determined 602 through the material handling requirement identification module 134.

In one or more embodiments, in contrast to the previously discussed embodiments, the gathering method step 606 is subsequent to the determining method step 602 rather than integrated therein, and is therefore presented in FIG. 6A as a solid box rather than phantom (as is the gather method step 604). Gathering 606 the information includes determining the presence of the respective objects that are to be retrieved at the respective locations. In some embodiments, the locations of the objects are determined by using sensors that can identify the locations. For example, in some embodiments, and without limitation, one or more sensors that include one or more visual sensors 720 (similar to the visual sensors 708), one or more proximity switches 722, and one or more weight sensors 724 (similar to the weight sensors 710).

In some embodiments, a portion of the objects that are anticipated for transport from the storage area 712 are positioned on respective weight sensors 724 such that relatively rapid object identification is facilitated. In addition, the material handling requirement identification module 134 is configured to determine one or more of the minimum, maximum, and optimum quantities of the objects to be transported by one or more of numbers of units and weight. For example, and without limitation, the numerical values for the individual weights of the respective objects are used to determine a value for a number of the units of the objects presently positioned to a respective weight sensor 724. In one or more embodiments, the information with respect to one or more characteristics of the one or more objects, i.e., the first objects 714 and the second objects 716. Accordingly, in contrast to the unloading embodiments previously described for the receiving area 702, these characteristics of the first objects 714 and the second objects 716 are already recorded and resident within the data 192 of the knowledge corpus 190 and do not need to be redundantly discovered. However, in some embodiments, redundant checking of the data 192 with subsequent data collection may occur on a periodic basis.

In some embodiments, the gathering method step 606 further includes executing image recognition for object identification by recording (through the visual sensors 720) and comparing (with the object data 192 through the material handling requirement identification module 134) characteristics of the objects such as, and without limitation, color, texture, temperature, and shape.

In one or more embodiments, the requirement for needing the first objects 714 and the second objects 716 to be transported from the storage area 712 to the assembly area 718 is triggered through, for example, a separate assembly management system (not shown) through, for example, and without limitation, some other computing device 120 over the network connections 118. Also, in some embodiments, rather than a separate assembly management system, the need for object transport is determined through sensors proximate the assembly area 718 such as, and without limitation, one or more sensors that include one or more visual sensors 726 (similar to the visual sensors 708 and 720), one or more proximity switches 728 (similar to the proximity switches 722), and one or more weight sensors 730 (similar to the weight sensors 710 and 724). In such embodiments, the quantities of the objects being used are monitored and one a respective threshold is reached, a request for transport of the respective objects to be transported from the storage area 712 to the assembly area 718 is automatically determined by the material handling requirement identification module 134. Accordingly, the present and intended locations, the numbers, sizes, weights, weight distributions, and natures (e.g., contents) of the objects determined 602 are further determined through the gathering information step 606.

The process 600 further includes determining 608, subject to the gathering 604/606 of information, one or more characteristics of the unitary material transport vehicle 575 to transport the one or more objects, i.e., the first objects 714 and the second objects 716 from the one or more first locations, i.e., the storage area 712 to the one or more second locations, i.e., the assembly area 718. As previously discussed, in a typical industrial facility, the objects and materials handled on the respective industrial floors are of different sizes and weights, which make them difficult to carry with conventional material handling vehicles, e.g. forklifts, etc. To efficiently handle these objects and materials, material transportation vehicles that can carry any item is required. However, excessively large material handling vehicles are inefficient and may pose a waste of resource availability. As such, the dimensions and other characteristics of the unitary material transport vehicle 575 are determined through one or more optimization algorithms resident in the material transport vehicle determination module 142. More specifically, the material transport vehicle determination module 142 is configured to constrain the physical dimensions of the unitary material transport vehicle 575 configuration depending on the number, size, weight, and weight distribution of the items to be carried from one location to another, where the aforementioned characteristics are determined through the gathering method step 604/606 as previously described. In some embodiments, the minimum size of the unitary material transport vehicle 575 is determined, and in some embodiments, a predetermined safety factor is added to that minimum value.

The determining method step 608 uses the data collected during the gathering method step 604/606 to determine the one or more characteristics of the unitary material transport vehicle 575 to transport the one or more objects, where the required characteristics of the unitary material transport vehicle 575 are determined, where such characteristics include, without limitation, the physical dimensions, speed requirements, acceleration requirements, and power requirements for the unitary material transport vehicle 575. As the determining method step 608 is executed for the characteristics of the unitary material transport vehicle 575, the physical floor plan of the industrial facility, including the expected routes between the various locations, is considered. For example, if the physical floor plan includes aisles and other such passages of a certain width, the unitary material transport vehicle 575 will be formed with a width most appropriate for the entirety of the planned routes, with considerations given to the characteristics of the planned load.

In addition, in some embodiments, the material transport vehicle determination module 142 is configured to determine any specialized transportation requirements for the planned load. At least a portion of the information for executing such a determination includes administrative information through one or more of the input devices 110, the cloud 116 via the Internet connections 114, and other computing devices 120 through the network connections 118, as well as historical shipping/receiving data 192 resident within the knowledge base 190. Such administrative information includes, without limitation, one or more of safety data sheets (SDSs), material safety data sheets (MSDSs), product safety data sheets (PSDSs), manufacturers' documentation, and materials from the National Fire Protection Association (NFPA) and the American Coatings Association's (ACA's) Hazardous Materials Identification System (HMIS®). As such, if specialized containers are necessary for transport of the planned materials due to one or more of chemical/biological characteristics, temperature requirements, material state (liquid, gaseous, powdery), collection and use of those specialized containers are integrated into the planned material transport.

Moreover, in some embodiments, the material transport vehicle determination module 142 is configured to determine if the transport requires single or multiple trips of a single material handling unit 200/300 or unitary material transport vehicle 575, and if multiple trips or multiple material handling units 200/300 or unitary material transport vehicles 575 are the best option. Also, such determinations include identifying if multiple materials are to be transported together, or if the materials need to be transported separately. Moreover, a determination is made as to whether a particular unitary material transport vehicle 575 will return from the drop-off location with a load to be delivered to the original location or a different location, or if the particular unitary material transport vehicle 575 will be making one or more round-trips.

In a least some embodiments, the determining method step 608 includes determining 610, subject to the determining method step 608 of at least a portion of the characteristics of the unitary material transport vehicle 575 as previously described, a number of material handling units 200/300 that will be used to form the unitary material transport vehicle 575 within the previously determined constraints. Moreover, in some embodiments, the material transport vehicle determination module 142 is configured to determine, through one or more optimization algorithms, using at least a portion of the previously determined constraints, the dimensions of the unitary material transport vehicle 575 and the combined engine power requirement. As previously described, these one or more optimization algorithms use the available volume and physical layout of the industrial facility to determine the dimensions of unitary material transport vehicle 575, where the dimensions are determined based on the calculated power requirements of the vehicle 575, the calculated weight of the materials and objects, and the determined weight distribution among these materials and objects. In some embodiments, the determined power-per-unit is calculated after determining the weight of the materials and objects and the number of material handling units 200/300 needed. This measurement is used to facilitate identification of eligible material handling units 200/300 for the task. If there are not enough eligible material handling units 200/300, an attempt to add more material handling units 200/300 to reduce the required power-per-unit and meet the minimum number of eligible material handling units 200/300 needed.

In some embodiments, an objective of optimizing the transport of the materials and objects is facilitated through determining the respective optimizing of the dimensions of the unitary material transport vehicle 575 by the one or more optimization algorithms. In addition, in some embodiments, if the unitary material transport vehicle 575 will return with new items, the optimization algorithms over-provision the unitary material transport vehicle 575 with additional material handling units 200/300 to account for the larger return payload. Accordingly, the combination of the two determining method steps 608 and 610 facilitate the design of the unitary material transport vehicles 575.

In one or more embodiments, the process 600 includes deploying 612, subject to the determining method step 610 of the number of material handling units 200/300 to be deployed, the plurality of material handling units 200/300 from one or more third locations to the one or more first locations. The deployment 612 is executed through the material transport vehicle formation module 144. In some embodiments, those material handling units 200/300 not in use are stored at one or more third locations, e.g., a unit storage area 732. In some embodiments, the material handling units 200 and 300 are stored together. In some embodiments, the material handling units 200 and 300 are stored separately. In some embodiments, the third location is a unit repair/refurbishment area 733. In some embodiments, the material handling units 200 use the flight mode to transport themselves (as indicated by the arrow 734) from the unit storage area 732 toward the receiving area 702. In some embodiments, all of the units 200 in transport are in the flight mode, in some embodiments, all of the units 300 in transport are in the floor mode, and in some embodiments, a portion of the units 200 released are in the flight mode and a portion of the units 300 released are in floor mode. In at least some embodiments, the material handling units 200 shift their modes from flight mode to floor mode such that a plurality of material handling units 300 in the floor mode are present at the receiving area 702. In some embodiments, one or more material handling units 200 are used to transport the rectangular boxes 706 in the flight mode. Accordingly, the material handling units 200/300 are directed 614 from the unit storage area 732 toward the receiving area 702 through the material transport vehicle formation module 144.

Referring to FIG. 6B, a continuation of the flowcharted process 600 shown in FIG. 6A is presented, in accordance with some embodiments of the present disclosure. Also, continuing to refer to FIGS. 1A-1B, 6A, and 7, in some embodiments, the plurality of material handling units 300 are used to dynamically assemble 616 the unitary material transport vehicle 575 with the previously determined number of units 300 in the previously determined unitary configuration. The deployment assembly 616 is executed through the material transport vehicle formation module 144. As such, the respective telescopic coupling devices 212 are deployed 618 between the material handling units 300 as shown and described with respect to FIG. 5. In some embodiments, the telescopic coupling sensors 214 facilitate determining 620 the integrity of the one or more telescopic coupling devices. In addition, in some embodiments, the telescopic coupling devices 212 are extendable with variable lengths that are used to increase the unit-to-unit strength when shortened to facilitate one section of the unitary material transport vehicle 575 as compared to other sections. In some embodiments, the variation of the lengths is executed automatically by the material transport vehicle formation module 144. In some embodiments, manual coupling and adjustments of the lengths of the telescopic coupling devices 212 are enabled.

In addition to horizontal formation of the material handling units 300 into the unitary material transport vehicle 575, in some embodiments, the material handling units 300 are configured to vertically assemble into a wall. In some embodiments, the telescopic coupling devices 212 are fully engaged on all appropriate sides of the respective material handling units 200 while in the flight mode per the respective telescopic coupling sensors 214 prior to the propellor/wheel devices 206 converting from flight mode to floor mode. In some embodiments, the propellor/wheel devices 206 are converted from flight mode to floor mode and then the telescopic coupling devices 212 are fully engaged on all appropriate sides of the respective material handling units 300 while in the floor mode per the respective telescopic coupling sensors 214.

Once the unitary material transport vehicle 575 is assembled 616, the objects and materials are loaded 622 and transported 624 as facilitated by the material loading module 146. In the receiving area 702 embodiment, the material handling units 300 assembled to form the unitary material transport vehicle 575 transport 624 the rectangular boxes 706 from the receiving area 702 to the storage area 712 as shown by the arrow 736. Only three material handling units 300 are shown; however, any number of material handling units 300 are used to assemble the unitary material transport vehicle 575. Once the unitary material transport vehicle 575 is assembled 616, the objects and materials are loaded 622 onto the unitary material transport vehicle 575. Such loading 622 of these objects and materials will typically require additional material handling mechanisms (in addition to any of the aforementioned devices discussed with respect to FIG. 2B), and manual human labor that can carry the objects and materials to bring these objects and materials close enough for unitary material transport vehicle 575 to be loaded. The weight sensors 710 are configured to be employed during the placement of the objects and materials onto the unitary material transport vehicle 575 to verify the weights, if desired.

In some embodiments, the visual sensors 708 and weight sensors 710 facilitate automatic, dynamic, real time modifications to the unitary material transport vehicle 575 as initially assembled. For example, and without limitation, for a scenario that a determination of more or fewer of the material handling units 300 is required, such units 300 are either summoned and added or dispatched away to be redeployed, respectively. Also, for example, different models of the material handling units 300 are needed for enhancing load stability and will be dynamically summoned and integrated into the unitary material transport vehicle 575. In addition, such automatic and dynamic adjustments to the unitary material transport vehicle 575 are executed while the vehicle 575 is enroute.

Once the rectangular boxes 706 are transported 624 and arrive at the storage area 712, they are offloaded 626 (as facilitated by the material unloading module 148) from the unitary material transport vehicle 575 to define the plurality of first objects 714. The unitary material transport vehicle 575 is disassembled into its component material handling units 300 that are then dispatched (as discussed further later), or the unitary material transport vehicle 575 is reassigned other transport tasks as is presently assembled (all as facilitated by the dispatch and disassembly module 150).

In the storage area 712-to-assembly area 718 transport embodiment, a plurality of material handling units 200/300 are directed toward the storage area 712 to form one or more unitary material transport vehicles 575 (only two material handling units 300 are shown). The unitary material transport vehicles 575 are loaded with at least a portion of the first plurality of objects 714 (as shown by arrow 738) and at least a portion of the plurality of second objects 716 (as shown by arrow 740), where they are transported to the assembly area 718 as shown by arrows 742 and 744, respectively. In some embodiments, upon delivery of the first objects 714 and the second objects 716 at the assembly area 718, they are used to assemble a product (not shown). Once the product is assembled, the product is loaded into a shipping container 746 as shown by the arrow 748. In some embodiments, the product is transported using the material handling units 200/300 and the unitary material transport vehicles 575 as described herein. In some embodiments, one or more visual sensors 726 (that are similar to the visual sensors 708 and 720), one or more proximity switches 728 (that are similar to the proximity switches 722), and one or more weight sensors 730 (similar to the weight sensors 710 and 724) are used as previously described to facilitate subsequent transport of the shipping container 746 using the system 100. Once the shipping container 746 is filled with the product, it is sealed and positioned at a shipping area 750 as shown by the arrow 752, where the positioning at the shipping area 750 is performed by one or more of the system 100 as described herein, additional transport mechanisms (forklifts, etc.), and manually. One or more unitary material transport vehicles 575 load the shipping container 746 into a shipping vehicle 754 as indicated by the arrow 756 using the systems and methods as previously described herein.

In at least some embodiments, including, without limitation, the receiving area 702-to-storage area 712 transport embodiment, the storage area 712-to-assembly area 718 transport embodiment, and the shipping container 746-into-the-shipping vehicle 754 transport embodiment, the process 600 includes discontinuing 628 the transporting 624 of the rectangular boxes 706, the first objects 714, the second objects 716, and the shipping containers 746, respectively.

Referring to FIG. 6C, a continuation of the flowcharted process 600 shown in FIGS. 6A and 6B is presented, in accordance with some embodiments of the present disclosure. Also, continuing to refer to FIGS. 1A-1B, 6A-6B, and 7, in some embodiments, the unitary material transport vehicle 575 is directed 630, i.e., dispatched to a fourth location, i.e., a disassembly location 758, where the unitary material transport vehicle 575 is at least partially disassembled 632. The directing/dispatching method step 630 and the disassembling method step 632 are facilitated through the dispatch and disassembly module 150. In some embodiments, the unitary material transport vehicle 575 is fully disassembled 632 at the most recent loading/unloading area. In some embodiments, the unitary material transport vehicle 575 is partially disassembled 632 at the most recent loading/unloading area and the individual portions are dispatched to either new jobs or the disassembly location 758 for further disassembly 632. In some embodiments, the unitary material transport vehicle 575 is fully disassembled 632 at the disassembly location 758 (as shown in FIG. 7) into the individual material handling units 300 once dispatched to the disassembly location 758 as shown by the arrow 760. Accordingly, once the objects and materials handling activities are completed, the unitary material transport vehicle 575 is dispatched 630 away from the loading/unloading area and is either partially or fully disassembled 632 at the determined disassembly location 758 into individual components that are, in some embodiments, smaller unitary material transport vehicles 575, individual material handling units 300, or some combination thereof.

In some embodiments, the disassembly 632 of the unitary material transport vehicle 575 into the constituent material handling units 200/300 is executed fully automatically. Specifically, the telescopic coupling devices 212 are automatically withdrawn from the adjacent material handling units 300 to facilitate the disassembly 632. In some embodiments, the telescopic coupling devices 212 are removed manually, and in some embodiments, each material handling unit 200/300 is equipped with equipment for securing the manually removed telescopic coupling devices 212 to the respective material handling unit 200/300. In some embodiments, the telescopic coupling devices 212 are stored proximate to the various areas and locations determined to be assembly and disassembly locations.

In one or more embodiments, the smaller unitary material transport vehicles 575 and the individual material handling units 300 are directed 634 from the fourth locations, i.e., the determined disassembly location 758, to a fifth location. In some embodiments, the fifth location is another location for loading and unloading objects and materials. In some embodiments, the fifth location is the unit storage area 732 or the unit repair/refurbishment area 733, where the material handling units 300 are inspected for damage, taken out of service for scheduled preventative maintenance, or scheduled for corrective maintenance based on data collected therefrom. In some embodiments, the individual material handling units 300 have their modes changed at the disassembly area 758 (as shown by the arrow 760) from floor to flight, and the individual material handling units 200 fly to their determined fifth location (as shown by the arrow 762). In some embodiments, the fifth location for dispatching the individual material handling units 300 and the unitary material transport vehicles 575 is determined through one or more of the standard dispatch rules determined by the system 100, including, without limitation, the distance of the units 200/300 and vehicles 575 to the fifth location, the time necessary for the units 200/300 and vehicles 575 to complete the journey, and the expected traffic conditions at specific points along the industrial floor.

In at least some embodiments, the process 600 includes collecting 636 data from one or more of each material handling unit 200/300 relevant to one or more of: operating each material handling unit 200/300 prior to assembling the unitary material transport vehicle 575; operating the plurality of material handling units 200/300 in the unitary configuration; the at least partial disassembling 632 of the unitary material transport vehicle 575; and transporting 624 each material handling unit 200/300 from the fourth location to one or more fifth locations. The data 192 is uploaded to the knowledge base 190 for storage and retrieval. For example, and without limitation, is some embodiments, metrics associated with the operations described herein are exported from each material handling unit 200/300 and analyzed for purposes of, without limitation, degraded, or degrading, features that will eventually, if not immediately, require attention. In addition, in some embodiments, the analyses are used to determine if further refinement of the operating features is achievable, and also determine any adjustments that may be required to achieve such desired improvements. Moreover, in some embodiments, at least a portion of the data 192 is used to further train, through the models learning module 154, one or more models resident in the model retaining module 156. Such training includes, without limitation, using feedback learning loops, etc., to alter operational methods to optimize the employment of each material handling unit 200/300, as well as the operation of the material handling tool 130. For example, in some embodiments, the data 192 ingested from the material handling units 200/300 is used to review the existing routing protocols/instructions for the material handling units 200/300, and if necessary, e.g., for a near collision, adjust the affected routing protocols/instructions to increase the margin of safety.

The embodiments as disclosed and described herein are configured to provide an improvement to the technological field associated with material handling vehicle management. As such, the embodiments described herein integrate the dynamic formation of a unitary material transport vehicle from a plurality of material handling units into a practical application that improves the functioning of the systems and technologies associated with vehicle management.

The embodiments described herein facilitate the aforementioned integration into a practical application of a computer system, computer readable storage medium, and computer-implemented method for identifying material handling requirements from one location to another location in any industrial facility through deriving the dimensions and weights of objects and materials requiring such transport. Once the details of the objects and materials to be transported are identified, the optimal attributes for a material transportation vehicle to transport the materials are determined. The material transportation vehicle is dynamically assembled through the dynamic coordination, in real time, of the constituent material transportation units that are directed to the appropriate area while in the flight mode. The material transportation units are converted from the flight mode to the floor mode, where the propellors of the flying units (in a manner similar to drones) are converted to wheels. The individual floor-configured units are mechanically joined together through shafts therebetween. The objects and materials are loaded onto the vehicle and the vehicle is converted to a wheel based transportation vehicle where it transports materials across an industrial floor.

Therefore, the embodiments presented herein provide efficient means for handling objects and materials in an industrial facility through the use of flying material movement units which can be dynamically formed to minimize their dimension, minimizing overhead space required for the overall system. The embodiments provided herein also provide for automatically and dynamically changing the number of flying units directed toward a location based on the number of objects and materials that need to be handled. Moreover, the unit makeup of the vehicle will be automatically and dynamically adjusted at the point of loading, while the vehicle is enroute, and after partial deliveries for those embodiments that facilitate a string of multiple loading and unloading stations, as a function of the size and weight of the objects and materials to be transported. In addition, since the vehicle is assembled with dynamic modification features, the embodiments presented herein facilitate the efficient use of resources through reducing the overall space required for storing the units and enhancing operational flexibility by modifying the shape and size of the vehicle dynamically through adding or subtracting units, or swapping out one type of unit for a different type of unit.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 8, a block schematic diagram is presented illustrating an example of a computing environment for the execution of at least some of the computer code involved in performing the disclosed methods described herein, in accordance with some embodiments of the present disclosure.

Computing environment 800 contains an example of an environment for the execution of at least some of the computer code involved in performing the disclosed methods, such as material handling vehicle management code 900. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

Computer 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

Processor set 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 821 and the other storage media discussed below. The program instructions, and associated data, are accessed by processor set 810 to control and direct performance of the disclosed methods. In computing environment 800, at least some of the instructions for performing the disclosed methods may be stored in block 900 in persistent storage 813.

Communication fabric 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

Persistent storage 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the disclosed methods.

Peripheral device set 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

Network module 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the disclosed methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

Remote server 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

Public cloud 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system for operating a plurality of material handling units in a unitary configuration comprising:
one or more processing devices;
one or more memory devices communicatively and operably coupled to the one or more processing devices;
a material handling tool at least partially resident within the one or more memory devices, the material handling tool configured to:
determine one or more objects to be transported from one or more first locations to one or more second locations;
gather, subject to the determining the one or more objects, information with respect to one or more characteristics of the one or more objects;
determine, subject to the gathering of information, one or more characteristics of a unitary material transport vehicle to transport the one or more objects from the one or more first locations to the one or more second locations;
determine, subject to the determining the one or more characteristics of the unitary material transport vehicle, a number of material handling units within a plurality of material handling units to form the unitary material transport vehicle; and
assemble the unitary material transport vehicle, wherein the unitary material transport vehicle includes the plurality of material handling units assembled into the unitary configuration.

2. The system of claim 1, the material handling tool further configured to:
direct the plurality of material handling units from one or more third locations to the one or more first locations.

3. The system of claim 1, the material handling tool further configured to:
deploy, subject to the determining of the number, the plurality of material handling units.

4. The system of claim 1, the material handling tool further configured to:
deploy one or more telescopic coupling devices between at least a first portion of the plurality of material handling units.

5. The system of claim 4, the material handling tool further configured to:
determine an integrity of the one or more telescopic coupling devices.

6. The system of claim 1, the material handling tool further configured to:
discontinue the transporting of the one or more objects from the one or more first locations to the one or more second locations;
direct the unitary material transport vehicle to a fourth location;
at least partially disassemble the unitary material transport vehicle into one or more second portions of the plurality of material handling units at the fourth location; and
direct each second portion of the material handling units from the fourth location to one or more fifth locations.

7. The system of claim 1, the material handling tool further configured to:
collect data from one or more of each material handling unit of the plurality of material handling units relevant to one or more of:
operate each material handling unit prior to assembling the unitary material transport vehicle;
operate the plurality of material handling units in the unitary configuration;
the at least partially disassembling of the unitary material transport vehicle; and
transport of each material handling unit of the plurality of material handling units from the fourth location to one or more fifth locations.

8. A computer readable storage medium having computer executable instructions that when executed by at least one computing device operate a plurality of material handling units in a unitary configuration, comprising instructions to:
determine one or more objects to be transported from one or more first locations to one or more second locations;
gather, subject to the determining the one or more objects, information with respect to one or more characteristics of the one or more objects;
determine, subject to the gathering of information, one or more characteristics of a unitary material transport vehicle to transport the one or more objects from the one or more first locations to the one or more second locations;
determine, subject to the determining the one or more characteristics of the unitary material transport vehicle, a number of material handling units within a plurality of material handling units to form the unitary material transport vehicle; and
assemble the unitary material transport vehicle, wherein the unitary material transport vehicle includes the plurality of material handling units assembled into the unitary configuration.

9. The computer readable storage medium of claim 8, further comprising instructions to:
direct the plurality of material handling units from one or more third locations to the one or more first locations.

10. The computer readable storage medium of claim 8, further comprising instructions to:
deploy, subject to the determining of the number, the plurality of material handling units.

11. The computer readable storage medium of claim 8, further comprising instructions to:
deploy one or more telescopic coupling devices between at least a first portion of the plurality of material handling units.

12. The computer readable storage medium of claim 11, further comprising instructions to:
determine an integrity of the one or more telescopic coupling devices.

13. The computer readable storage medium of claim 8, further comprising instructions to:
discontinue the transporting of the one or more objects from the one or more first locations to the one or more second locations;
direct the unitary material transport vehicle to a fourth location;
at least partially disassemble the unitary material transport vehicle into one or more second portions of the plurality of material handling units at the fourth location; and
direct each second portion of the material handling units from the fourth location to one or more fifth locations.

14. A computer-implemented method for operating a plurality of material handling units in a unitary configuration comprising:
determining one or more objects to be transported from one or more first locations to one or more second locations;
gathering, subject to the determining the one or more objects, information with respect to one or more characteristics of the one or more objects;
determining, subject to the gathering of information, one or more characteristics of a unitary material transport vehicle to transport the one or more objects from the one or more first locations to the one or more second locations;
determining, subject to the determining the one or more characteristics of the unitary material transport vehicle, a number of material handling units within a plurality of material handling units to form the unitary material transport vehicle; and
assembling the unitary material transport vehicle, wherein the unitary material transport vehicle includes the plurality of material handling units assembled into the unitary configuration.

15. The method of claim 14, further comprising:
directing the plurality of material handling units from one or more third locations to the one or more first locations.

16. The method of claim 14, further comprising:
deploying, subject to the determining of the number, the plurality of material handling units.

17. The method of claim 14, wherein the assembling the unitary material transport vehicle comprises:
deploying one or more telescopic coupling devices between at least a first portion of the plurality of material handling units.

18. The method of claim 17, further comprising:
determining an integrity of the one or more telescopic coupling devices.

19. The method of claim 14, further comprising:
discontinuing the transporting of the one or more objects from the one or more first locations to the one or more second locations;
directing the unitary material transport vehicle to a fourth location;
at least partially disassembling the unitary material transport vehicle into one or more second portions of the plurality of material handling units at the fourth location; and
directing each second portion of the material handling units from the fourth location to one or more fifth locations.

20. The method of claim 19, further comprising:
collecting data from one or more of each material handling unit of the plurality of material handling units relevant to one or more of:
operating each material handling unit prior to assembling the unitary material transport vehicle;
operating the plurality of material handling units in the unitary configuration;
the at least partially disassembling of the unitary material transport vehicle; and
transporting each material handling unit of the plurality of material handling units from the fourth location to one or more fifth locations.
